(19) United States
(12) Patent Application Publication
(10) Pub. No.: US 2009/0247007 A1
(43) Pub. Date: Oct. 1, 2009

(54) PATCH PANEL FRAME WITH BEZEL AND REAR MOUNTED MODULE

(76) Inventor: Luc MILETTE, Montreal (CA)

Correspondence Address: GOUDREAU GAGE DUBUC, 2000 MCGILL COLLEGE, SUITE 2200, MONTREAL, QC, H3A 3H3, CA

(21) Appl. No.: 12/411,657

(22) Filed: Mar. 26, 2009

Related U.S. Application Data
(60) Provisional application No. 61/039,569, filed on Mar. 26, 2008.

(51) Int. Cl. H01R 13/66

(52) U.S. Cl. 439/540.1

(57) ABSTRACT

There is provided a patch panel for mounting thereto a plurality of keystone style modular jacks each comprising a forward portion having a plug receiving opening moulded therein. The patch panel comprises a flat frame comprising a first plurality of like rectangular openings, each one of the first plurality of openings adapted to receive one of the plurality of jacks, and a bezel arranged behind the frame substantially co-planar therewith and comprising a second plurality of like rectangular openings, each one of the second plurality of openings aligned with and of dimensions greater than one of the first plurality of openings. The bezel has a width for accommodating the forward portion of the plurality of jacks when the plurality of jacks are received in aligned pairs of the first and the second plurality of openings. When one of the plurality of jacks is positioned within one of the second plurality of openings, the plug receiving opening is accessible via one of the first plurality of openings.

### CROSS REFERENCE TO RELATED APPLICATIONS

This application claims priority from U.S. provisional application Ser. No. 61/039,569, filed on Mar. 26, 2008, which is incorporated herein in its entirety by reference.

### FIELD OF THE INVENTION

The present invention relates to a patch panel frame with bezel and rear mounted module.

### BACKGROUND OF THE INVENTION

Although keystone style modular jacks are well known in the art, patch panel frames typically fail to accommodate keystone style modular jacks made in accordance with industry standards, especially at the rear of the patch panel frame due to the width of the modular jack. To overcome these difficulties, prior art assemblies use patch panels, typically one-piece mould die cast, that have a thickness equal to the dimensions of the modular jack in order to accommodate the latter, thus resulting in thick and bulky designs. Other mounting assemblies use modular multi-port modules tailored to a specific performance. Alternatively, the keystone style modular jacks are accommodated on faceplates, bezels, mounting brackets, or the like, attached to the patch panel frame. Still, a major drawback of these assemblies is the complex and expensive nature of the design and construction. Other prior art patch panel assemblies accommodate the keystone style modular jacks on a single frame in order to maximize patch panel density, thus saving money and rack space. Although this results in patch panels of simple construction, in high density applications these structures suffer from a low strength and structural rigidity, as the frame is not reinforced and is thus susceptible to damage due to bending forces or the like.

What is therefore needed, and an object of the present invention, is a simplified patch panel assembly that can accommodate a standard keystone modular jack at the rear side of the patch panel while providing structural strength and eliminating costly tooling for plastic or die casting mould.

### SUMMARY OF THE INVENTION

More specifically, in accordance with the present invention, there is provided a patch panel for mounting thereto a plurality of keystone style modular jacks each comprising a forward portion having a plug receiving opening moulded therein. The patch panel comprises a flat frame comprising a first plurality of like rectangular openings, each one of the first plurality of openings adapted to receive one of the plurality of jacks, and a bezel arranged behind the frame substantially co-planar therewith and comprising a second plurality of like rectangular openings, each one of the second plurality of openings aligned with and of dimensions greater than one of the first plurality of openings. The bezel has a width for accommodating the forward portion of the plurality of jacks when the plurality of jacks are received in aligned pairs of the first and the second plurality of openings. When one of the plurality of jacks is positioned within one of the second plurality of openings, the plug receiving opening is accessible via one of the first plurality of openings.

Other objects, advantages and features of the present invention will become more apparent upon reading of the following non-restrictive description of specific embodiments thereof, given by way of example only with reference to the accompanying drawings.

### BRIEF DESCRIPTION OF THE DRAWINGS

FIG. 1 is a front perspective view of a patch panel with bezel in accordance with an illustrative embodiment of the present invention;

FIG. 2 is a detailed front perspective view of a patch panel with bezel in accordance with an illustrative embodiment of the present invention;

FIG. 3 is a rear perspective view of a patch panel with bezel having modular jacks mounted thereon in accordance with an illustrative embodiment of the present invention;

FIG. 4A is a perspective view of a keystone modular jack in accordance with an illustrative embodiment of the present invention; and

FIG. 4B is a side view of a keystone modular jack in accordance with an illustrative embodiment of the present invention.

### DETAILED DESCRIPTION OF THE ILLUSTRATIVE EMBODIMENTS

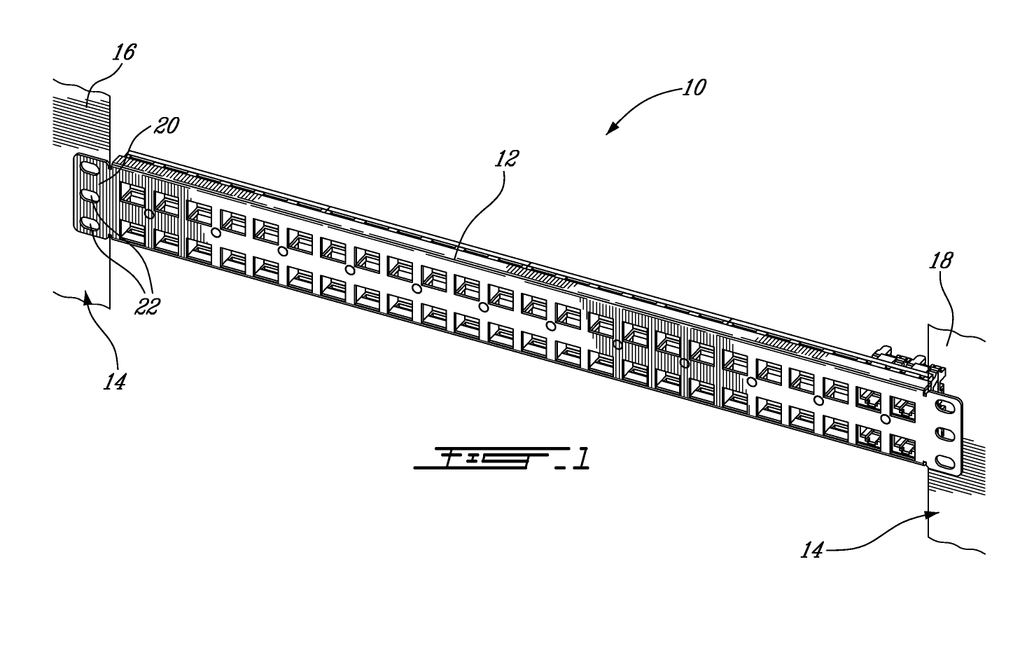

Referring now to FIG. 1, and in accordance with an illustrative embodiment of the present invention, a patch panel assembly, generally referred to using the reference numeral 10, will now be described. The patch panel assembly 10 comprises at least one keystone patch panel 12 mounted to a standard network rack 14 (e.g. EIA/TIA 19-inch rack) comprising two spaced vertical side rails 16 and 18. Mounting plates as in 20 are formed integrally with the keystone patch panel 12 at each extremity thereof and comprise mounting apertures as in 22, which allow the keystone patch panel 12 to be mounted to the rails 16 and 18 using fasteners such as nuts, bolts, and the like (not shown).

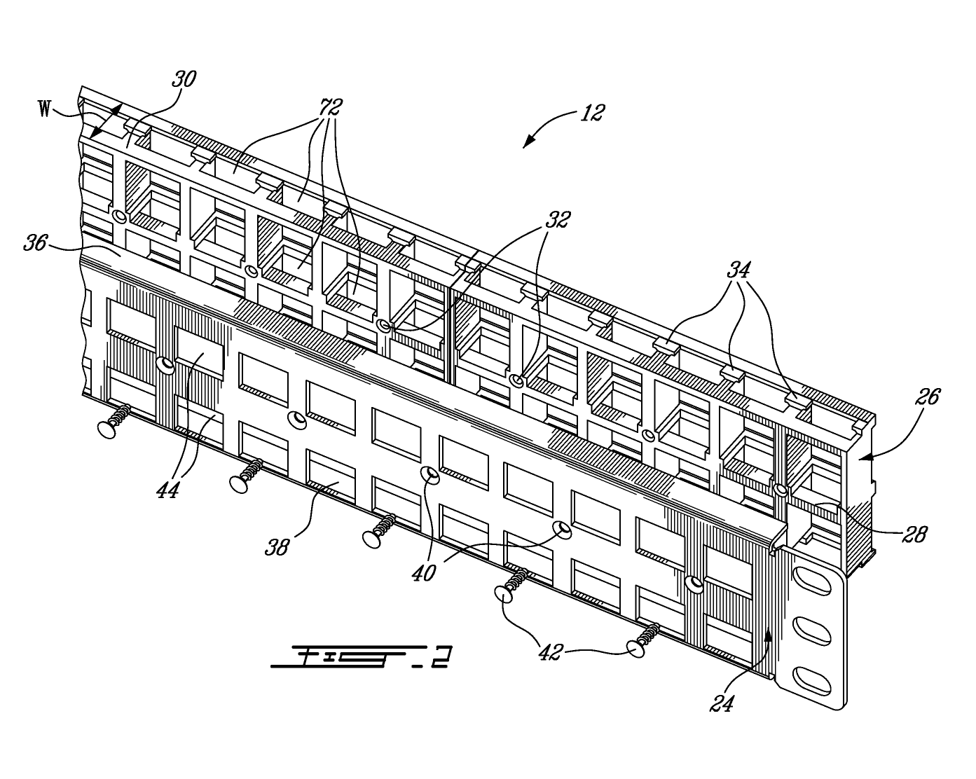

Referring now to FIG. 2, the patch panel 12 illustratively comprises a planar frame 24 and a bezel 26 fixedly attached substantially co-planar to a rear face of the frame 24 for providing reinforcement to the patch panel 12. The bezel 26, which is formed of any material (e.g. plastic) known by those skilled in the art to be suitable for this use, illustratively comprises a housing (not shown) defined by a front face 28, a rear face (not shown), an upper face 30 and a lower face (not shown). The front face 28 and the rear face of the bezel 26 comprise a plurality of mounting apertures as in 32 for attachment of the bezel 26 to the frame 24. The upper face 30 and the lower face of the bezel 26 each comprise a retention bar 34 which, when the bezel 26 is mated with the frame 24, abuts against a top strip 36 and a bottom strip 38 of the frame 24, thus securing the bezel 26 in place relative to the frame 24. Illustratively, the top strip 36 and the bottom strip 38 respectively project rearwardly from an upper edge and a bottom edge (both not shown) of the frame 24 at a substantially right angle. The frame 24 is further provided with a plurality of mounting apertures as in 40 aligned with the mounting apertures as in 32 machined into the bezel 26. The bezel 26 is illustratively mated with the frame 24 and fixedly attached thereto using fasteners as in 42, such as screws, bolts, or the like, inserted into pairs of aligned mounting apertures as in 32 and 40.

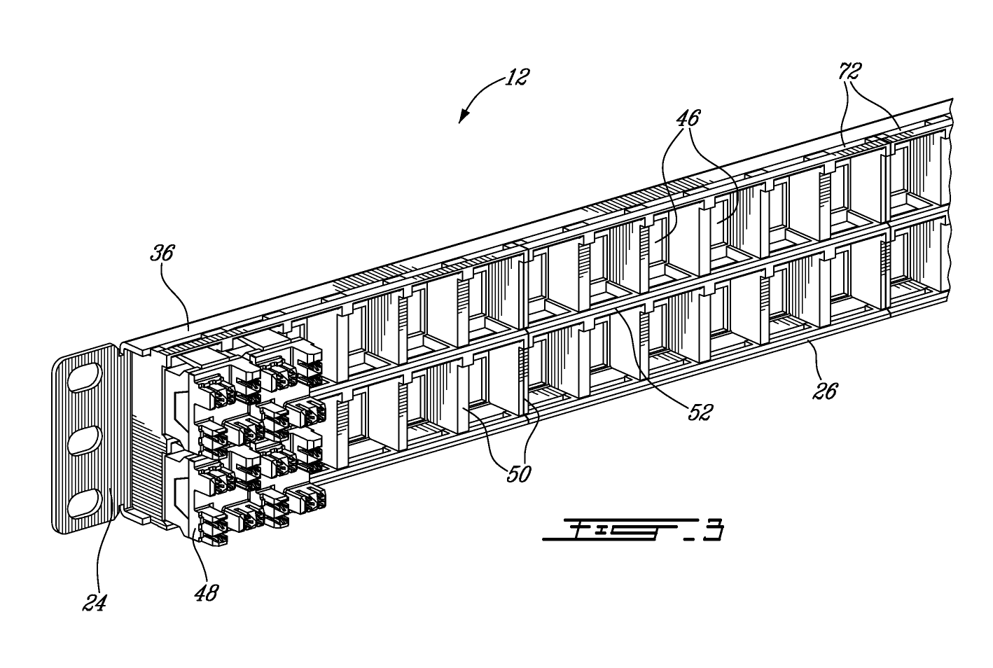

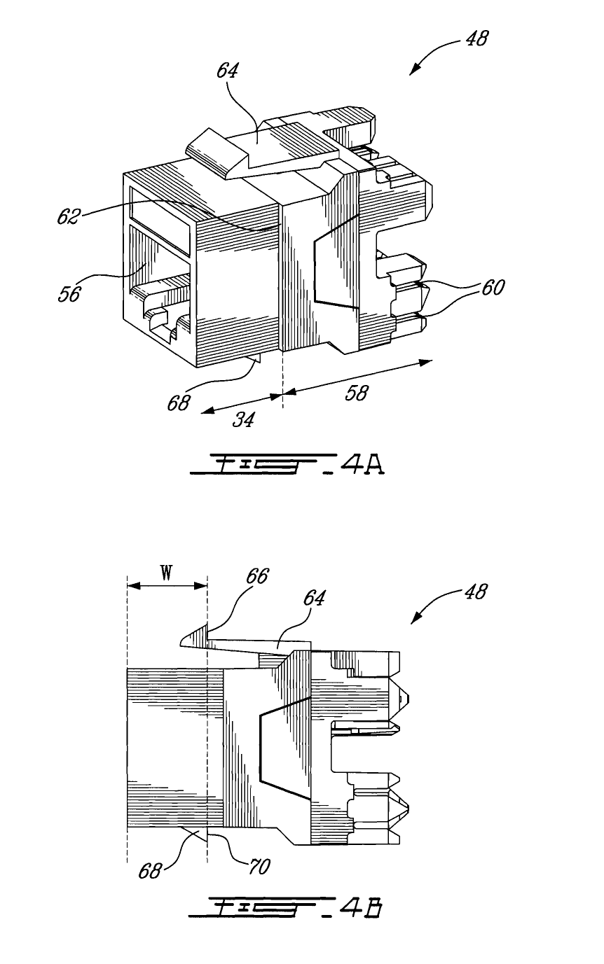

Referring now to FIG. 3, FIG. 4A, and FIG. 4B in addition to FIG. 2, the frame 24 and the bezel 26 respectively comprise a plurality of openings as in 44 and 46, which are aligned respective to one another as well as sized and shaped (e.g. rectangular) to receive therein modular jacks as in 48. Illustratively, the openings as in 46 extend from the front face 28 to the rear face of the bezel 26 and are defined by a plurality of vertical partitions as in 50 and a horizontal center partition 52, which spans the horizontal length of the bezel 26. The modular jacks as in 48 are illustratively keystone modular jacks but it will be apparent to a person skilled in the art that other types of latching mechanisms, such as the AMP Netconnect™ style jacks or the like, could be used without departing from the scope of the present invention. Also, each modular jack 36 is inserted from the rear of the patch panel 12 substantially straight into a pair of aligned openings as in 44 and 46 and, as such, the distance between two vertically stacked modular jacks as in 48 is minimized.

Still referring to FIG. 3, FIG. 4A, and FIG. 4B in addition to FIG. 2, a keystone modular jack 48 typically comprises a forward portion 54 having moulded therein a plug receiving opening 56 adapted to receive a mating plug (not shown), for example an RJ-45 style plug, and a rearward portion 58 having a plurality of terminals as in 60 for terminating individual conductors of a cable (not shown). Illustratively, the forward portion 54 is separated from the rearward portion 58 by a retaining ridge 62 extending along the contour of the rearward portion 58, such a contour being typically slightly larger than that of the forward portion 54. Thus, it is desirable for the openings as in 44 of the frame 24, which receive the forward portion 54 of the keystone modular jacks as in 48, to be substantially smaller than the openings as in 46, which receive the rearward portion 58. In this manner, the patch panel 12 properly accommodates the size and shape of the keystone modular jacks as in 48, which are secured within the openings as in 44 and 46 by the retaining ridge 62 bearing against the rear face of the bezel 26. Still, as mentioned herein above, the combination of the frame 24 with the bezel 26 is provided to improve the structural rigidity of the patch panel 12. Additionally, the front face of the frame 24 is provided for aesthetic purposes. Thus, the openings as in 44 could be larger than the openings as in 46, as desired, while still providing the requisite reinforcement. Alternatively, a single opening 44 could encompass a plurality (e.g. two (2)) of openings as in 46, thus allowing a plurality of plug receiving openings as in 56 to be accessible from the front of the patch panel 12 via a single opening 44.

Still referring to FIG. 3, FIG. 4A, and FIG. 4B in addition to FIG. 2, in order to provide sufficient spacing to accommodate the width W of the forward portion 54 when the keystone modular jack 48 is mounted to the rear of the patch panel 12 within the openings 44 and 46, the bezel 26 is designed to have a width W from the front face 28 to the rear face of the bezel 26. In this manner, when the keystone modular jack 48 is mounted to the patch panel 12, the front of the keystone modular jack 48 will be flush with the front face of the frame 24, with the plug receiving opening 56 being accessible via the opening 44. Alternatively, the width W may be selected so that the keystone modular jack 48 is slightly recessed into or protrudes from the frame 24.

Still referring to FIG. 3, FIG. 4A, and FIG. 4B in addition to FIG. 2, the keystone modular jack 48 further comprises on an upper surface thereof a forwardly extending cantilevered latch arm 64 (having at a distal end thereof a stop surface 66) and on a lower surface thereof a raised angled rib 68 (having a stop surface 70) for securing the keystone modular jack 48 to the patch panel 12. In order to accommodate the latch 64 and the rib 68, the upper face 30 and the lower face of the bezel 26 each comprise a plurality of recesses as in 72 provided between consecutive vertical partitions as in 50. When the bezel 26 is mounted to the frame 24, the retention bars as in 34 abut against the upper strip 36 and the lower strip 38 of the frame 24 and the strips 36 and 38 partially obstruct each recess 72 (as illustrated in FIG. 3), with the unobstructed portion still providing sufficient space for engaging the stop surface 66 of the latch 64 and the stop surface 70 of the rib 68 of each keystone modular jack 48. Moreover, the center partition 52 illustratively comprises recesses as in 72 for engaging the latch 64 of a first keystone modular jack 48 and the rib 68 of a second keystone modular jack 48 when the two keystone modular jack as in 48 are vertically stacked. In this manner, all keystone modular jacks as in 48 are securely mounted to the patch panel 12.

Referring back to FIG. 1, the present invention advantageously provides a patch panel assembly 10 that accommodates standard keystone modular jacks as in 48 at the rear of the patch panel 12 using a simple design and construction, in which the thickness of the patch panel 12 is of no significance, thus proving less expensive than keystone patch panels currently known in the art. Also, providing a frame (reference 24 in FIG. 2) having a bezel (reference 26 in FIG. 2) attached thereto significantly improves the structural strength and rigidity of the patch panel assembly 12, which can thus advantageously sustain strong bending forces or the like without damage thereto.

Although the present invention has been described hereinabove by way of specific embodiments thereof, it can be modified, without departing from the spirit and nature of the subject invention as defined in the appended claims.

What is claimed is:

1. A patch panel for mounting thereto a plurality of keystone style modular jacks each comprising a forward portion having a plug receiving opening moulded therein, the patch panel comprising:
a flat frame comprising a first plurality of like rectangular openings, each one of said first plurality of openings adapted to receive one of the plurality of jacks; and
a bezel arranged behind said frame substantially co-planar therewith and comprising a second plurality of like rectangular openings, each one of said second plurality of openings aligned with and of dimensions greater than one of said first plurality of openings;
wherein said bezel has a width for accommodating the forward portion of the plurality of jacks when the plurality of jacks are received in aligned pairs of said first and said second plurality of openings;
and further wherein when one of the plurality of jacks is positioned within one of said second plurality of openings, the plug receiving opening is accessible via one of said first plurality of openings.
